(19) United States
(12) Patent Application Publication
(10) Pub. No.: US 2004/0064391 A1
(43) Pub. Date: Apr. 1, 2004

(54) Method and system for life settlement contract securitization and risk management

(76) Inventor: Jeffrey Lange, New York, NY (US)

Correspondence Address: KENYON & KENYON, ONE BROADWAY, NEW YORK, NY, 10004, US

(21) Appl. No.: 10/256,979

(22) Filed: Sep. 26, 2002

(51) Int. Cl. G06F 17/60

(52) U.S. Cl. 705/36

(57) ABSTRACT

This invention provides methods and systems for the efficient securitization and risk management of life settlement contracts. The advantages of the present invention include the ability to create securities derived from diverse pools of life insurance related obligations by managing, disaggregating, and recombining the risks of the underlying life insurance obligations into newly created securities of high credit quality termed Collateralized Life Settlement Obligations (“CLSO”), which can then be offered for sale or as collateral for repurchase (repo) transactions thereby facilitating an efficient and low-cost source of capital for acquiring the underlying life insurance related obligations.

### FIELD OF THE INVENTION

The present invention relates generally to systems and methods for securitizing life settlement contracts and more particularly for creating new securities termed Collateralized Life Settlement Obligations (CLSO) from such contracts.

### BACKGROUND OF THE INVENTION

The total face amount of life insurance currently in force in the United States is approximately $20 trillion, according to the insurance research and rating firm A.M Best.

This figure represents a very large proportion of the total amount of financial assets owned by U.S. households and is about the same magnitude as the total capitalization of the U.S. debt and equity markets combined and is over twice as large as the total value of residential real estate in the U.S. which is estimated at approximately $9 trillion. While life insurance is clearly an enormous asset class in the U.S., it is also the least liquid financial asset. Up until very recently, no secondary market existed for reasonably healthy insureds desiring to sell their policies and the only source of liquidity for insureds was the issuing insurer—typically, in the form of a cash surrender value or policy loan.

Very recently, a secondary market for life insurance called the life or senior settlement market has emerged. In a typical life settlement transaction, an insured sells his in force policy to a life settlement broker or similar financial intermediary. The insured transfers all rights—e.g., cash surrender value, death benefit, etc.—and all obligations—e.g., future required premium payments—to the intermediary in consideration for a lump sum payment. The amount of the lump sum payment should reflect the present value of the rights of the policy less its obligations, adjusted for the mortality risk of the insured, the expected duration of the death benefit, the credit risk of the insurer, the nature and quality of the underlying assets, if any, determining the value of the rights and obligations, and other relevant risks. In many cases, the fair value of the insured's policy can greatly exceed the cash surrender value, thereby providing a strong incentive for the development of a secondary market. In addition, an insured may desire to sell the policy for other reasons, such as a change in factors motivating the initial life insurance purchase. For example, since the original issuance of the policy, the insured may have experienced a change in health status, estate planning goals, financial condition, tax planning goals, employment status (e.g., so called “key man” policies held by the insured's business may no longer be needed), marital and family circumstances, and similar factors relevant to purchasing and maintaining an in force policy. In addition, the insured may desire to diversify the credit risk inherent in a life insurance policy: the credit ratings of life insurers imply significant default risk and an insured may wish to eliminate this substantial exposure to the fortunes of a single life insurer.

Given the aggregate amounts of life insurance in force, a liquid secondary market for policies will require significant amounts of capital from institutional investors. Other potentially large financial markets have in the past benefited greatly from the process of securitization, wherein diverse underlying pools of obligations bearing varying risk and expected return characteristics have been reassembled, rated, and packaged into classes of securities. These securities are then purchased (or subject to repurchase or “repo” transactions which is a form of securitized lending) by institutional investors such as fixed income asset managers. Various methods exist in the financial industry to securitize such obligations as mortgage loans, credit card receivables, commercial loans, and corporate bonds. One form of securitization has been described in U.S. Pat. No. 6,088,685, creating securities from open end mutual funds so that such funds can be transacted in continuous time.

No means to securitize life settlement contracts have been established. Such contracts are inherently more difficult and less amenable to securitization. The following characteristics of life settlement contracts make their securitization much more difficult than other obligations:

1. Mortality Extension Risk: An insured may live longer than the expected time of death as indicated by an actuarial assessment of the insured, given his current health status, age, etc. This risk is of great consequence to an investor as delays in receiving cash flows derived from death benefits lowers the investor's rate of return. More problematic from the perspective of the investor, this mortality extension risk may not be entirely idiosyncratic or diversifiable in that advances in medical technology and healthcare may reduce average mortality rates for the entire portfolio of life settlement contracts. Mortality extension risk therefore poses new securitization challenges.

2. Collateral diversity: Life insurance policies vary greatly in terms of premium payment schedules, death benefits, cash surrender value, underlying lives insured, and exposure to interest rate, equity, credit and other risks. For example, term, universal, variable, whole, variable universal, and second-to-die life insurance policies all have varying rights, obligations, and risks which are illiquid, sometimes ill-defined, and invariably more difficult to disaggregate and value compared to the risks borne by, for example, mortgage loans and other assets which have heretofore been widely securitized. Since all of these types of policies can be sold via a life settlement contract, an efficient means of securitization of the underlying risks in the policies can significantly reduce the cost of funding the purchase of the underlying policies.

3. Credit Risk: Most owners of life insurance probably do not reflect much upon the credit risk inherent in the policy. Yet, many life insurers have credit ratings which imply that the risk of default is quite high, especially when cumulated over the inherently long horizon of a life insurance policy. For example, many life insurance companies maintain an “A” rating from Standard and Poors. An “A” rated life insurance company may have to pay its bondholders up to several hundred basis points per annum above the rate required on default-free securities (e.g., U.S. Treasury securities) thereby implying a probability of default of several percent per annum. Over a period of 10 to 20 years, the premium that life insurance companies must pay to their bondholders imply significant chances of default, perhaps 30, 40 or 50% or more. Yet life insurance policyholders, unlike bondholders, are unlikely to be focused on this risk. An insured, however, may find it desirable to sell his policy to eliminate the unwanted credit exposure to the life insurance company. The credit exposure must then be valued and managed so that the underlying policies can be reconstituted as CLSO's, the majority of which preferably can obtain a higher credit rating than the underlying insurance policies.

4. Interest Rate Risk: Many varieties of life insurance combine a standard death benefit feature with an investment in a financial product. Universal life insurance products combine a fixed income investment product with standard life insurance death benefits. Both the required premium payments and the death benefit can be variable, depending upon the rate of growth in the investment product. Typically, policyholders receive floating rate interest on their investment product and therefore tend to be “short” relative to the bond market in the sense that universal life insurance will perform less well when bond prices are rising then when they are falling. In any event, the increased contractual complexity and interest rate risk inherent in these types of policies can make securitization more difficult.

5. Equity Risk: Some types of life insurance products—such as variable life insurance—have premium obligations, death benefits, and cash surrender values which are tied to the performance of a broad array of financial products selected by the insured. Insureds typically select financial products which bear significant and systematic equity exposure, such as a mutual fund which indexes its performance to the S&P 500. These exposures entail an added dimension of securitization complexity.

6. Negative Cash Flows: An in force life insurance policy may require ongoing periodic premium payments in order to prevent the policy from lapsing. The purchaser of the policy assumes the obligations of any future premium obligations. From the perspective of the purchaser, a life settlement contract may therefore entail significant negative cash flows reflecting the ongoing premium obligations. Underlying assets with such negative cash flows have typically not been the subject of securitization efforts and pose additional challenges.

7. Mortality Covariance: The mortality risks associated with the underlying life settlement contracts may have complicated statistical structures, heretofore unknown in existing areas of securitization. For example, so-called second-to-die or joint survivor policies typically insure married couples and pay death benefits upon the death of the last surviving spouse. The mortality rates of lives insured in such policies are not statistically independent and pose further complications for efficient securitization.

8. Mark-to-Market Difficulties: Both a cause and a consequence of the lack of a liquid secondary market in life insurance is the difficulty in ascertaining the fair value of a policy at any point in time. The value of a policy is a complex function of mortality rates, insurer credit risk, interest rate and other market risk, and options embedded in the terms of the policy. The challenges in obtaining timely and accurate valuations—or mark-to-market values—for the underlying life settlement contracts have inhibited efficient means of securitization.

9. Identity Security: The owner of a life settlement contract or security derived from such contract has a direct financial interest in the mortality experience of the lives insured by the underlying insurance policies. It is therefore desirable to protect the insureds from potential criminal activity by protecting the identity of the insureds and keeping any information that could identify the insureds secure from the ultimate owners of the CLSOs.

### SUMMARY OF THE INVENTION

One feature of the present invention is to provide efficient means of securitization of life settlement contracts.

A need is recognized for methods and systems to securitize life settlement contracts which will lower the cost of capital required to acquire such contracts in a secondary market for life insurance policies.

To achieve this invention, as embodied and broadly described herein, one method for securitizing Collateralized Life Settlement Obligations comprises the steps of: transferring a plurality of underlying life insurance related obligations into at least one of a special purpose corporation, limited partnership, entity and vehicle; acquiring data related to at least one characteristic of the plurality of underlying life insurance related obligations; determining a covariance of the acquired data; measuring at least one of an economic value and a risk of the plurality of the underlying life insurance related obligations, as a function of the acquired data and the covariance; and providing a plurality of new obligations having varying risk and economic return features of the plurality of the underlying life insurance related obligations.

In another aspect, a method for creating a plurality of new obligations from a plurality of acquired life settlement contracts, wherein some of the newly created obligations may have lower mortality extension, credit, interest rate, and other related risk than the original obligations, wherein a plurality of these lower risk securities are then rated by a credit rating agency such as Standard and Poors, Moodys, or Fitch to have a high credit quality rating; registering such high credit quality obligations as securities, and then selling or lending such securities to institutional investors.

In a further aspect, the invention comprises a method for creating a special purpose entity of high credit quality with an initial amount of investment capital, using this investment capital to acquire a plurality of life insurance policies by executing life settlement contracts with the owners of such policies, appointing a trustee to administer the acquired life insurance policies by paying ongoing premium obligations and receiving policy benefits, appointing a portfolio manager to acquire mortality, credit, interest rate, and other market and policy data relevant to the economic value of the acquired insurance policies, performing a valuation of the underlying life insurance policies with such data with such valuation step including the steps of computing the expected time of cash flows received and paid out and a statistical distribution of such times wherein such distribution reflects the mortality, credit, interest rate and other relevant market and policy data, whereby such distribution may be computed using Monte Carlo simulation, value at risk, and similar methods, creating a plurality of senior class securities which are protected from the mortality, credit, interest rate and other market risks in a manner such that cash flows for the senior class of securities are received on or before a stated date with high statistical confidence and creating a plurality of less senior classes of securities with cash flows that are received with a lower statistical confidence.

Other objects and advantages exist for the present invention.

### BRIEF DESCRIPTION OF THE DRAWINGS

FIG. 1 is a schematic representation of a system for creating Collateralized Life Settlement Obligations according to an embodiment of the present invention.

FIG. 2 is a chart illustrating an example method of the present invention wherein new securities called Collateralized Life Settlement Obligations are created from a plurality of underlying life settlement contracts.

### DETAILED DESCRIPTION OF THE INVENTION

The present invention is described in relation to systems and methods for the creation of new types of financial securities which are termed herein Collateralized Life Settlement Obligations (CLSO). A CLSO is a security which has a value which depends upon the financial performance of an underlying set of obligations called life settlement contracts. A life settlement contract, sometimes also called a “senior settlement” or “viatical” contract (the latter in the case of a terminally ill insured) is an assignment of rights and obligations pursuant to a life insurance policy of an individual insured. The type of policy subject to a life settlement contract may vary, and may include term, whole, variable, universal, variable universal, key man, second-to-die or joint survivor and other life insurance policies.

The present invention relates to a means of providing a large and cost-efficient source of institutional capital for the creation of a liquid secondary market for life insurance policies. Until very recently, an insured whose life insurance needs have changed since original policy origination faced a limited choice: surrender the policy to the insurer and recover any available cash surrender value or let the policy lapse to avoid paying future premiums. Both options fail to offer the insured the fair economic value of the policy, which is approximately the present value of the expected death benefit, less the present value of any future premium obligations. A secondary market has recently emerged in which an insured can enter into a life settlement contract with a broker or other financial intermediary. Under the terms of a life settlement contract, the insured assigns all or part of his benefits under the policy to the buyer in consideration for a known cash payment or payments. The buyer of the policy assumes all or part of future premium payments. In essence, the buyer of the insurance policy is effectively buying a financial asset resembling a bond from the insured, wherein the bond's cashflows are stochastic depending upon the life expectancy of the insured, the default of the insurer, and other possible risks. In addition, the cashflows received by the buyer might actually be negative, as the buyer may be required to pay the issuing insurance company ongoing premiums to keep the policy in force. Insureds may desire to sell their policies at fair market values rather than surrender them for cash surrender values for a variety of reasons not limited to:

(1) A insured may have estate planning goals or financial or family obligations which are materially different from those which existed at the time the insurance policy was originally issued;

(2) A business may own a key man life insurance policy on an employee no longer with the firm;

(3) An insured may have suffered an adverse change in health status making the policy significantly more valuable than the cash surrender value;

(4) An insured may desire to diversify or eliminate the risk that the issuing insurer will default upon its obligations.

Currently, the secondary market for life insurance policies is small and fragmented. While some institutional capital has been attracted for acquisition of policies, there have been no systematic attempts to create liquid and high rated securities from pools of life settlement contracts, wherein such securities would have the same high credit quality and liquidity as other asset backed securities such as mortgage pass-through securities. The object of this invention is to provide methods and systems for the securitization of liquid and highly rated securities derived form life settlement contracts. One aim of the present invention is to provide the means to create CLSO securities which will have comparable liquidity and credit quality to the asset-backed securities currently available.

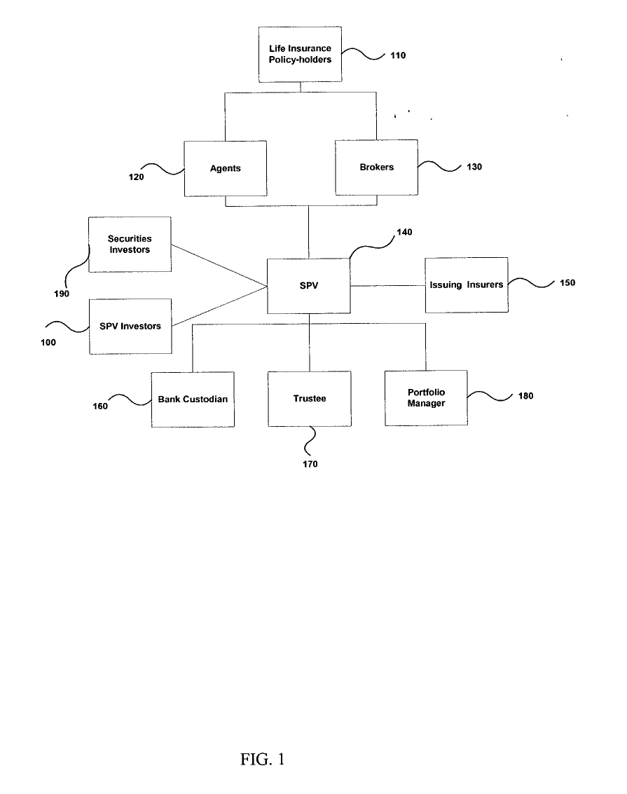

FIG. 1 is a schematic representation of a system for creating Collateralized Life Settlement Obligations according to an embodiment of the present invention. According to an embodiment of this invention, the system may comprise a special purpose vehicle (SPV) 140, SPV investors 100, life insurance policyholders 110, life insurance agent 120, life settlement broker 130, issuing insurance companies 150, bank custodian 160, trustee 170, portfolio manager 180, and securities investor 190. As illustrated in FIG. 1, various parts of the system may interact with other parts of the system via exchange of information and cashflows pursuant to financial transactions. The SPV 140 may be any type of entity capable of transacting such business, such as a corporation, partnership, limited liability company, limited partnership, limited liability partnership, or trust. The SPV 140 may also conduct other business in addition to CLSO business.

In one embodiment, SPV 140 is established as a legal corporate or partnership entity. SPV investors 100 provide investment capital to SPV 140 and own the equity interest in the SPV. As an independent financial entity, SPV 140 may, in one embodiment, seek to be rated of high credit quality such as “AAA” or “AA” by a credit rating agency such as Standard and Poors. Life insurance agents 120 and life settlement contract brokers 130 arrange with life insurance policyholders 110 to purchase a variety of life insurance policies. These policies may be of the term, whole, variable, universal variable, universal, key man, second-to-die, annuities, or other similar types of life insurance products typically underwritten by issuing insurers 150. The SPV 140 provides investment capital to the agents 120 and the brokers 130 to purchase the life insurance policies from policyholders 110. The SPV acquires the rights and obligations of the life insurance policies through life settlement contracts executed with the life insurance policyholders. The SPV 140 assumes all rights and obligations under the purchased life insurance policies in consideration for cash payments to the policyholders. A transaction fee may be paid to the agents 120 or brokers 130 upon the final execution of a life settlement contract. As administered and directed by the trustee 170, the SPV makes any ongoing premium payments to issuing insurers 150 required pursuant to the obligations of the underlying acquired insurance policies to maintain the policies in force. Upon the death of the insured policyholders, the trustee 170 administers the receipt of death benefits from the issuing insurers 150. In particular, the trustee also safeguards the identities of the insureds from all interested, and potentially interested, financial parties. All financial assets of the SPV 140 are held with bank custodian 160. Portfolio manager 180 analyzes the mortality, interest rate, equity, credit and other relevant risk of the cashflows derived from the life settlement contracts owned by the SPV 140. In one embodiment, the portfolio manager may perform the steps of (1) acquiring all actuarial, capital market, and other data relevant to the economic value of the underlying life settlement contracts; (2) perform a mark-to-market valuation of such contracts by computing the present value of the expected net discounted cashflows derived from the plurality of life settlement contracts owned by the SPV 140 wherein such valuation step involves computing an expected value under the best available probability distributions for mortality, interest rate, credit, equity and other relevant risks; (3) creating new obligations from the plurality of life settlement contracts owned by SPV 140 wherein some of the newly created securities have different expected return and risk characteristics from the original cashflows derived from the life settlement contracts; (4) obtaining ratings for such newly created securities from, for example, a credit rating agency such as Standard and Poors wherein a plurality of the newly created securities have a credit rating as high or higher than would otherwise be the case for the original life settlement contracts; (5) selling or offering for repurchase such newly created and rated securities to securities investors 190 whereby cashflows from such selling or repurchasing of securities are administered by trustee 170. The sale or repurchase transactions allow SPV 140 to free up equity capital so that additional purchases of life insurance policies via life settlement contracts can be completed without requiring additional capital from SPV investors 100.

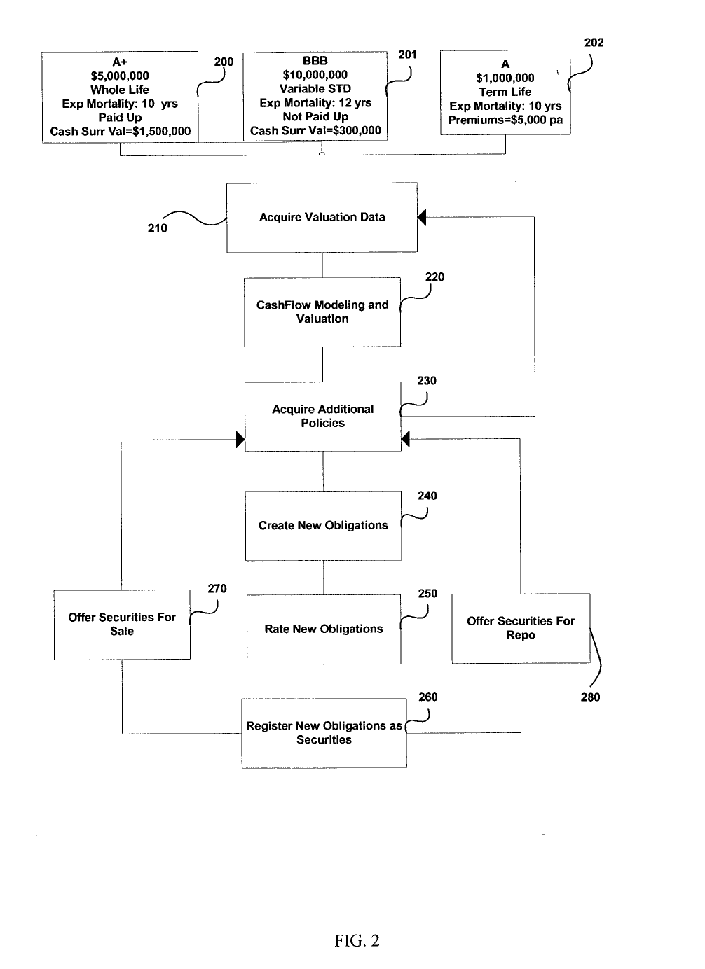

FIG. 2 is a chart illustrating an example method of the present invention wherein new securities called Collateralized Life Settlement Obligations are created from a plurality of underlying life settlement contracts. Policies 200, 201, and 202 illustrate example types of insurance policies that may be the subject of life settlement contracts which transfer all rights and obligations away from the policyholder in consideration for cash payment. Other types of life insurance polices may be the subject of such transactions. By way of example, policy 200 is a $5,000,000 whole life policy issued by an insurer with an A+ credit rating. The life expectancy of the underlying insured, based upon the insured's current health status and age, is 10 years. The policy is fully paid up (no remaining premium obligations) and has a cash surrender value of $1,500,000. Policy 201 is a $10,000,000 variable second-to-die policy from a BBB rated insurer. The policy pays a minimum guaranteed death benefit of $10,000,000 upon the death of the surviving spouse. The premiums of the policy are $100,000 per annum with a current cash surrender value of $300,000. Based upon an actuarial assessment of the two lives insured, the policy's death benefit has an expected payment date of 12 years. Because the policy is a variable policy in which the level of the death benefit and the amount of premium payments made depend upon the performance of the insureds' selection of investment products, the capital markets risks of policy 201 may be more complex than for whole life policy 200. On the other hand, variable policies are typically not subject to the general account credit risk of the issuing insurer as the investment assets which find the death benefit are held in a segregated account. The credit risk of such a policy may therefore be superior to a whole life policy. Policy 202 is a term life insurance policy owned by an insured who has suffered a recent adverse change in health status. The life expectancy of the insured is 5 years and the premium payments for the $1,000,000 death benefit are $5,000 per annum. Since policy 202 is a term policy, there is no cash surrender value. The issuing insurer of policy 202 has an “A” credit rating. Illustrative of this invention is the ability to provide methods and systems for securitization of disparate underlying insurance policies as depicted by way of example in 200, 201, and 202.

Referring again to FIG. 2, step 210 illustrates the acquisition of valuation data by, for example, a portfolio manager (for example, portfolio manager 180 illustrated in FIG. 1) for the purpose of producing a fair valuation of policies 200, 201, 202 to be acquired. The fair value of a policy is approximately equal to the present value of its expected net cash flows. The net cash flows are policy benefits less premium obligations to be paid. The expectation must be taken under relevant stochastic variables as the cash flows of policies 200, 201, and 202, for example, are typically random and not deterministic. Two important stochastic variables are the time of the policy insured(s) death and the time of default of the issuing insurer. As an example, consider policy 200. As described above, this policy is fully paid up so there are no further premium obligations. The policy has a fixed $5,000,000 death benefit and the issuing insurer has outstanding debt obligations rated A+ by Standard and Poors. As one substep of data acquisition step 210, a portfolio manager may acquire annual probabilities of death for the insured in a given year based upon the insured's current health status, insurance records, and actuarial assessments. The data may be in the form of cumulative probabilities of death to a certain future date, the probability of death within a given year in the future, or the probability of death in a given year conditional upon survival to that year, sometimes referred to as the “hazard rate.” In addition, data acquisition step 210 may acquire data related to the probability of default of the issuing insurer. The probability of default data may be based upon rates implied from the interest rates paid by the insurer on its debt obligations, historical default probabilities tabulated by credit rating agencies, or quantitative methodologies such as the EDF measure published by KMV. Other valuation data that may be relevant, in particular for variable insurance policies, are the forward prices and volatilities of selected financial assets held in the variable policy segregated accounts.

Step 220 of FIG. 2 performs the modeling and valuation of the distribution of cashflows from the underlying life settlement contracts. The purpose of step 220 is twofold. First, step 220 performs a valuation analysis on each individual life insurance policy under consideration for purchase or which has been purchased. This analysis determines either a fair price for acquisition of the policy or an accurate mark-to-market of a previously acquired policy. For example, for the illustrative whole life policy in 200, the following data might be used to determine a fair value of the policy:

TABLE 1

| | | Issuer | Issuer Discount | |
|---|---|---|---|---|
| Year | Mortality in Year | Borrowing | Factor | Death Benefit |
| 1 | 0.0188 | 0.0400 | 0.9615 | 5,000,000.00 |
| 2 | 0.0210 | 0.0410 | 0.9237 | 5,000,000.00 |
| 3 | 0.0232 | 0.0420 | 0.8864 | 5,000,000.00 |
| 4 | 0.0254 | 0.0430 | 0.8499 | 5,000,000.00 |
| 5 | 0.0276 | 0.0440 | 0.8141 | 5,000,000.00 |
| 6 | 0.0298 | 0.0450 | 0.7790 | 5,000,000.00 |
| 7 | 0.0320 | 0.0460 | 0.7448 | 5,000,000.00 |
| 8 | 0.0342 | 0.0470 | 0.7113 | 5,000,000.00 |
| 9 | 0.0364 | 0.0480 | 0.6787 | 5,000,000.00 |
| 10 | 0.0386 | 0.0490 | 0.6470 | 5,000,000.00 |
| 11 | 0.0408 | 0.0500 | 0.6162 | 5,000,000.00 |
| 12 | 0.0430 | 0.0510 | 0.5863 | 5,000,000.00 |
| 13 | 0.0452 | 0.0520 | 0.5573 | 5,000,000.00 |
| 14 | 0.0470 | 0.0530 | 0.5293 | 5,000,000.00 |
| 15 | 0.0496 | 0.0540 | 0.5022 | 5,000,000.00 |
| 16 | 0.0518 | 0.0550 | 0.4760 | 5,000,000.00 |
| 17 | 0.0540 | 0.0560 | 0.4508 | 5,000,000.00 |
| 18 | 0.0562 | 0.0570 | 0.4264 | 5,000,000.00 |
| 19 | 0.0584 | 0.0580 | 0.4031 | 5,000,000.00 |
| 20 | 0.0606 | 0.0590 | 0.3806 | 5,000,000.00 |

The vector product of the mortality probability for each given year (column 2) and the year index in column 1 yields the expected value of the year of the death benefit which in this illustration is equal to 9.81. Column 3 contains the borrowing cost of the issuing insurer (in this case, as illustrated in step 200, the insurer is rated A+) as, for example, available from the issuer screen from Bloomberg using the CDSW function. The fourth column is the present value of a dollar cashflow in the indicated year using the indicated borrowing cost from column 3. The vector product of columns 2,4, and column 5 which contains the $5,000,000 death benefit should death occur in the indicated year, is equal to $2,344,320 which is the net present expected value of the benefit under the illustrated policy. Similar types of calculations may also be used to obtain similar valuations of the insurance policy's cashflows.

Second, step 220 also produces a distribution of cash flows for the entire portfolio of policies already acquired, possibly together with policies that are under consideration to be acquired. This step is valuable to determine the effect an additional policy will have on the portfolio of previously acquired policies. In addition, this step allows for the determination of statistical distributions of the stochastic cash flows derived from the policies on certain dates in the future. For example, for a given portfolio of many policies (not necessarily the ones indicated in 200, 201, and 202), it may be desirable to compute the statistical distribution of death benefits payable in the next calendar year or any subsequent year. Such distributions could, for example, be readily performed using analytical assumptions about the mortality distributions and their covariance. Alternatively, a Monte Carlo simulation could be performed using data from the acquisition step 210. A hypothetical Monte Carlo simulation performed pursuant to modeling and valuation step 220 might show, for example, the following distribution of death benefits in the coming calendar year for a large portfolio of life settlement contracts:

TABLE 2

| Cumulative | Net Cash Flow Year |
|---|---|
| Probability | 1 |
| 0.0220 | 11,200,000 |
| 0.0584 | 11,157,340 |
| 0.1302 | 11,083,008 |
| 0.1812 | 10,968,723 |
| 0.2272 | 10,966,766 |
| 0.3031 | 10,646,629 |
| 0.3432 | 10,470,055 |
| 0.3872 | 10,228,957 |
| 0.4166 | 9,808,386 |
| 0.4604 | 9,768,023 |
| 0.5569 | 9,755,411 |
| 0.6026 | 9,287,390 |
| 0.6926 | 9,249,115 |
| 0.7285 | 9,248,658 |
| 0.7865 | 9,155,537 |
| 0.8117 | 9,004,525 |
| 0.8775 | 8,808,374 |
| 0.9270 | 8,311,066 |
| 0.9579 | 8,135,693 |
| 0.9700 | 7,700,650 |
| 0.9850 | 7,533,112 |
| 0.9920 | 7,038,648 |
| 1.0000 | 6,804,296 |

Table 2 illustrates, for example, that a Monte Carlo simulation of net cashflows for a given calendar year might show net cashflows of $7,533,112 with 98.5% probability. Such a simulation might be used, in one embodiment, to create new securities with new cashflows derived from the newly created obligations. For example, a new security might promise to pay $7,000,000 at the end of the calendar year illustrated in Table 2. As the simulation results from Table 2 illustrate, a cashflow of $7,000,000 or more has a probability of occurrence of greater than 99.2%. A series of cashflows which have probabilities of occurrence that are this high could be, in one embodiment, be used to create a new security.

Referring to step 230 of FIG. 2, after performing the modeling and valuation step 220, a plurality of additional policies under consideration may be acquired. In one embodiment, the policies are acquired for consideration less than or equal to the fair values calculated in step 220.

Step 240 is the step of securitization, whereby new securities are created from the underlying life settlement contracts which have transferred the rights and obligations of the underlying life insurance policies to the SPV 140 of FIG. 1. In one embodiment, a plurality of the new securities have different expected return and risk characteristics from the cashflows derived from the underlying life settlement contracts. In one embodiment, the creation of new securities follows the modeling and valuation step 220 whereby statistical distributions of cashflows per calendar time periods may be created. In one embodiment, a plurality of newly created securities may be created in which some newly created securities are protected from delays in payment of cashflows due to lower than expected mortality rates. In another embodiment, some of the securities may also be protected from delays or nonpayment in cashflows due to the default of the issuing insurer. As an example, consider again the statistical distribution of cashflows illustrated in Table 2, above. These cashflows are the result of simulating the rights and obligations of a plurality of underlying life settlement contracts (not necessarily those illustrated in 200, 201, and 202). The mean cashflow illustrated is $9,746,846. If mortality rates are very much higher, a cashflow as high as $11,200,000 may be received. Conversely, of mortality rates are much lower than expected, a cashflow as low as $6,804,296 may be received. The standard deviation of the illustrated cashflows is $1,021,985. As part of step 240, a new security might be created in which, for example, the newly created security has cashflows which have a different mean and standard deviation in the illustrated calendar year. For example, a new security might be created which has a maturity of 1 year. The security might, in one embodiment and by way of example, promise to pay $9,000,000 in a year, i.e., zero coupon bond with face amount of $9,000,000 to be paid in a year. This security would be a “mortality senior” security in that any risk in a mortality slowdown is not borne by this security. Instead, the mortality slowdown or extension risk is borne by another newly created security called the “mortality junior” security. The following table illustrates the cash flows of the newly created securities based upon the illustration of Table 2, above.

TABLE 3

| Cumulative | Net Cash Flow Year | | |
|---|---|---|---|
| Probability | 1 | Senior | Junior |
| 0.022 | 11,200,000 | 9,000,000 | 2,200,000 |
| 0.0584 | 11,157,340 | 9,000,000 | 2,157,340 |
| 0.1302 | 11,083,008 | 9,000,000 | 2,083,008 |
| 0.1812 | 10,968,723 | 9,000,000 | 1,968,723 |
| 0.2272 | 10,966,766 | 9,000,000 | 1,966,766 |
| 0.3031 | 10,646,629 | 9,000,000 | 1,646,629 |
| 0.3432 | 10,470,055 | 9,000,000 | 1,470,055 |
| 0.3872 | 10,228,957 | 9,000,000 | 1,228,957 |
| 0.4166 | 9,808,386 | 9,000,000 | 808,386 |
| 0.4604 | 9,768,023 | 9,000,000 | 768,023 |
| 0.5569 | 9,755,411 | 9,000,000 | 755,411 |
| 0.6026 | 9,287,390 | 9,000,000 | 287,390 |
| 0.6926 | 9,249,115 | 9,000,000 | 249,115 |
| 0.7285 | 9,248,658 | 9,000,000 | 248,658 |
| 0.7865 | 9,155,537 | 9,000,000 | 155,53 |
| 0.8117 | 9,004,525 | 9,000,000 | 4,525 |
| 0.8775 | 8,808,374 | 9,000,000 | −191,626 |
| 0.927 | 8,311,066 | 9,000,000 | −688,934 |
| 0.9579 | 8,135,693 | 9,000,000 | −864,307 |
| 0.97 | 7,700,650 | 9,000,000 | −1,299,350 |
| 0.985 | 7,533,112 | 9,000,000 | −1,466,888 |
| 0.992 | 7,038,648 | 9,000,000 | −1,961,352 |
| 1 | 6,804,296 | 9,000,000 | −2,195,704 |

As can be seen from Table 3, the senior security receives $9,000,000 irrespective of mortality rates. It is protected from all mortality risk. The junior security must therefore bear the loss if mortality rates drop unexpectedly, and will otherwise gain if mortality rates increase. The two newly created securities have very different return and risk characteristics from the original set of cashflows illustrated in Table 2. Other securities might be created in which a plurality of securities are senior or are protected from risk other than mortality, such as credit risk, interest rate risk, equity market risk, or other such risks which are associated with the portfolio of underlying life settlement contracts.

Step 250 obtains a rating for the newly created securities from a credit rating agency such as Standard and Poors, Fitch, or Moodys. Such a rating may be applied to some, none, or all of the newly created securities from step 240. In particular, in one embodiment, a plurality of the newly created securities will obtain a credit rating that is higher than the rating that might be obtained from the underlying life settlement contract obligations. For example, the senior security illustrated in Table 3 from step 240 above which has been immunized from mortality risk might receive a “AA” rating from Standard and Poors.

Step 260 registers the newly created obligations as securities. Securities are created promising to pay the cashflows under the circumstances illustrated. Such securities, for example, may be private placement or shelf registered securities.

Step 270 offers the newly created and rated securities for sale. Buyers of the securities could be mutual fund, hedge fund, insurers, reinsurers, banks, or individuals or other investors which typically invest in securities, typically of the fixed income variety. The manner in which the securities are created in step 240 may influence the likely investors which will buy such securities and at what price. For example, the senior securities of step 240 as illustrated in Table 3 might be purchased at a slight discount to the $9,000,000 face amount by a money market mutual fund. The junior securities might be purchased by a life reinsurer as a hedge against its existing liabilities. Since the junior securities of step 240 profit as mortality rates increase, they offer a natural hedge to life insurance liabilities which typically suffer losses when mortality rates increase. By creating securities which have a particular appeal to a particular investor, the total price obtained for such securities in step 270 can be maximized. As indicated in FIG. 2, the proceeds from the sale of the newly created securities can be used to acquire additional life insurance policies in step 230.

Alternatively, step 280 makes the newly created securities available as collateral in a repurchase or “repo” transaction. In one embodiment, the senior securities might used as collateral for a loan, typically from an investment or commercial bank or similar financial institution. For example, if such senior securities have a very high rating such as “AA” as illustrated in step 250, a very attractive borrowing rate may be obtained from a bank using the “AA” securities as collateral. This borrowing rate may be lower than that otherwise available had security creation step 240 and rating step 250 not been performed and the underlying life settlement contracts were pledged as collateral in raw form. As indicated in FIG. 2, the proceeds from borrowing capital in step 280 using the newly rated securities as collateral can be used to acquire additional life insurance policies in step 230.

In the preceding specification, the present invention has been described with reference to specific exemplary embodiments thereof. Although many steps have been conveniently illustrated or described in a sequential manner, it will be appreciated that steps may be reordered or performed in parallel. It will further be evident that various modifications and changes may be made thereunto without departing from the broader spirit and scope of the present invention as set forth in the claims that follow. The description and drawings are accordingly to be regarded in an illustrative rather than restrictive sense.

What is claimed is:

1. A method for securitizing collateralized life settlement obligations comprising the steps of:
transferring a plurality of underlying life insurance related obligations into a special purpose vehicle;
acquiring data related to at least one characteristic of the plurality of underlying life insurance related obligations;
determining a covariance of the acquired data;
determining, as a function of the acquired data and the covariance, an economic value, a risk or both of the plurality of the underlying life insurance related obligations; and
providing a plurality of new obligations having varying risk, at least one economic return feature, or both of the plurality of the underlying life insurance related obligations.

2. The method according to claim 1, further comprising the step of obtaining credit ratings for the plurality of new obligations.

3. The method according to claim 1, wherein the step of determining the economic value or the risk or both includes the step of performing a Monte Carlo simulation of cash flows of the underlying life insurance related obligations.

4. The method according to claim 1, wherein the at least one characteristic comprises a mortality extension risk.

5. The method according to claim 1, wherein the at least one characteristic comprises an interest rate risk.

6. The method according to claim 1, wherein the at least one characteristic comprises a credit risk.

7. The method according to claim 1, wherein the at least one characteristic comprises an equity risk.

8. The method according to claim 1, wherein the underlying life insurance related obligations are issued by a plurality of companies.

9. The method according to claim 8, wherein the plurality of companies includes at least ten companies.

10. The method according to claim 8, wherein the plurality of companies includes at least twenty companies.

11. The method according to claim 8, wherein the plurality of companies includes at least fifty companies.

12. The method according to claim 1, wherein none of the underlying life insurance related obligations have been issued by the special purpose vehicle.

13. The method according to claim 1, wherein at least one of the underlying life insurance related obligations have been issued by the special purpose vehicle.

14. A collateralized life settlement obligation.

15. A new obligation produced according to the method of claim 1.

16. The new obligation of claim 15, wherein at least one obligation has a lower mortality risk than the underlying life settlement obligations.

17. The new obligation of claim 15, wherein at least one obligation has a lower credit risk than the underlying life settlement obligations.

18. The new obligation of claim 15, wherein at least one obligation has a lower mortality risk and a lower credit risk than the underlying life settlement obligations.
